(19) United States
(12) Patent Application Publication
(10) Pub. No.: US 2013/0215069 A1
(43) Pub. Date: Aug. 22, 2013

(54) APPARATUS FOR NETWORK BASED MODULAR ELECTRONIC SYSTEMS

(71) Applicants: Tsu-Chang Lee, Palo Alto, CA (US); Syed Jauher Abbas Zaidi, Fallbrook, CA (US)

(72) Inventors: Tsu-Chang Lee, Palo Alto, CA (US); Syed Jauher Abbas Zaidi, Fallbrook, CA (US)

(21) Appl. No.: 13/881,694

(22) PCT Filed: Oct. 26, 2011
(86) PCT No.: PCT/US11/57866

§ 371 Date: Apr. 25, 2013

Related U.S. Application Data
(60) Provisional application No. 61/406,946, filed on Oct. 26, 2010.

(51) Int. Cl. G06F 3/14

(52) U.S. Cl. CPC G06F 3/1423
USPC 345/173; 345/1.3; 345/156; 345/87

(57) ABSTRACT

A modular electronic system includes network modules and network processors connected in a network topology. At least one embodiment is object-oriented, and one embodiment is a modular television. Each network module has a respective function module. Each network processor communicates with one or more network modules via respective serial or parallel interfaces. Each network processor has a data switch, a local memory and an object indexing engine. Data is moved among the network modules, the data switch, the local memory and the network processors. The network modules and network processors include electronic circuits, which may be integrated circuits. At least one of the network modules or network processors is individually removable from the modular electronic system for replacement or upgrading. Further network modules or further network processors can be added to the modular electronic system. The television embodiment includes display, memory, interface, communication, CPU and power modules.

### TECHNICAL FIELD

The present disclosure relates generally to modular electronic systems and network systems. At least one embodiment relates to modular television systems.

### BACKGROUND ART

Electronic systems are changing at a rapid pace. Cellular phones, PCs (personal computers), laptop computers, touchpad computers, PDAs (personal digital assistants), videogame consoles and other consumer electronic devices are frequently replaced after a very short life cycle. This creates problems such as environmental damage and resource wastage, as well as high cost for the consumer.

One direction to improve resource utilization and reduce environmental damages is to seek re-use of the majority of the parts of the system through modular system integration and evolution.

It would be desirable to have a modular system integration framework to enable flexible and incremental system evolution and reuse of modules.

PCs have long had a type of modularity, in that circuit cards can be removed from a card cage having a backplane and replaced or upgraded, and new circuit cards can be added. Motherboards can be replaced. Videogame consoles have had memory expansion modules that can be added, and have had ROM cartridges that are replaceable to install new games. Laptop computers have had PCMCIA slots allowing replaceable or new cards.

A modular television is shown in U.S. Pat. No. 3,708,618, with a plurality of modules in a drawer and coupled by connectors for easy removal and replacement. Yet, further improvements in modularity of electronic systems are sought, which may be applied to consumer electronic devices.

### SUMMARY

A modular electronic system connects removable, reusable or replaceable modules using a network topology. The modular electronic system is suitable for use in electronic devices such as a modular television and other consumer electronic products.

In one embodiment, an object-oriented modular electronic system includes network modules and object network processors. Each network module has a function module implementing a function associated with an object. Each network module is addressable in the system as a resource bindable to an object.

The object network processors are interconnected. Each object network processor communicates with one or more of the network modules. The communication between an object network processor and one or more network modules is via one or more serial or parallel interfaces.

Each object network processor has a data switch, a local memory and an object indexing engine. The data switch, local memory and object indexing engine are interconnected. The data switch, local memory and object indexing engine are configured to move data associated with an object among one or more network modules, the data switch, the local memory and a neighboring one or more of the object network processors.

The network modules and the object network processors include electronic circuits. At least one of the network modules or at least one of the object network processors is individually removable from the modular electronic system for replacement or upgrading. Further network modules or further object network processors can be added to the modular electronic system.

In a further embodiment, an object-oriented modular electronic system includes a first plurality of network modules and a second plurality of object network processors. The network modules communicate respective object-oriented data via respective serial or parallel interfaces. The object-oriented data is sent, received or operated upon by a respective function module inside each of the network modules.

The object network processors are connected in a network topology. Each object network processor is connected to one or more of the network modules via the respective serial or parallel interfaces. Each object network processor has a data switching network controller, a memory controller, a local memory, and an object indexing engine. The object indexing engine controls moving the object-oriented data. The object-oriented data is moved to and from one or more of the network modules, via the data switching network controller. The object-oriented data is moved to and from the local memory via the memory controller. The object-oriented data is moved to and from a neighboring one or more of the object network processors, via the data switching network controller.

Each of the network modules and each of the object network processors includes one or more integrated circuits. At least one of the network modules or at least one of the object network processors is individually removable from the modular electronic system for replacement or upgrading. Further network modules can be added to the modular electronic system. Further object network processors can be added to the modular electronic system.

In a still further embodiment, a modular television includes a first plurality of network modules and a second plurality of object network processors. The network modules communicate via respective serial or parallel interfaces. Data is sent, received or operated upon by a respective function module inside each of the network modules. Each network module has a respective network buffer memory for buffering the data. The network modules include a human interface module, a flash memory module, a hard disk module, a wireless or wired communication network module, a DRAM module, a CPU module, a display module and a power supply module as the respective function modules.

The object network processors are connected in a network topology. Each object network processors connected to one or more of the network modules via the respective serial or parallel interfaces. Each object network processor has a data switching network controller, a memory controller, a local memory, and an object indexing engine. The object indexing engine establishes and adapts indexes for the objects to optimize system quality and performance, thereby contributing to controlling the movement of the data. The data is moved to and from one or more of the network modules via the data switching network controller. The data is moved to and from the local memory via the memory controller. The data is moved to and from a neighboring one or more of the object network processors via the data switching network controller.

Each of the network modules and each of the object network processors includes one or more integrated circuits. At least one of the network modules or at least one of the object network processors is individually removable from the modular television for replacement or upgrading. Further modules or further object network processors can be added to the modular television.

### BRIEF DESCRIPTION OF THE DRAWINGS

FIG. 1 illustrates a block diagram of a Network Based Modular Electronic System, in accordance with one embodiment of the present invention.

FIG. 2 illustrates an embodiment of the Modular Electronic System of FIG. 1, using Network Processors to create a System Integration Object Network as the backbone of the system.

FIG. 3 illustrates a consumer product having a display module and further specified modules as an example of the Modular Electronic System of FIG. 1.

FIG. 4 illustrates an example of the Modular Electronic System of FIG. 1, having multiple DRAM modules.

FIG. 5 illustrates an example of the Modular Electronic System of FIG. 1, having a power supply configuration using multiple power source modules connected to the System Integration Object Network.

FIG. 6 illustrates an embodiment of a network module of FIG. 1 using buffer memory and an Object Channel Controller.

FIG. 7 illustrates a further embodiment of a network module of FIG. 1, having a Network Buffer Memory, a Network Buffer Processor and a Network Object Wrapper.

FIG. 8 illustrates an embodiment of the Modular Electronic System of FIG. 1, in a modular display system.

FIG. 9 illustrates an array of sensors or actuators embedded in a display device and communicating with an embodiment of the System Integration Object Network of FIG. 2.

FIG. 10 illustrates an embodiment of the Object Network Processor shown in the System Integration Object Network of FIG. 2.

FIG. 11 illustrates an embodiment of the Modular Electronic System of FIG. 1 implemented using three-dimensional die packaging technology.

FIGS. 12-15 illustrate embodiments of the System Integration Object Network of FIG. 2 with various network topologies.

FIG. 16 illustrates an embodiment of the Modular Electronic System of FIG. 1 being updated or configured using an Internet connection.

FIG. 17 illustrates a virtual system realized by integrating multiple System Integration Object Networks through the Internet, using multiple embodiments of the Modular Electronic System of FIG. 16.

FIG. 18 illustrates an interactive television or other system including a display device, based on the Modular Electronic System of FIG. 1.

FIG. 19 illustrates an embodiment of the interactive television of FIG. 18, including Network Modules connected to the System Integration Object Network.

FIG. 20 illustrates a flow diagram for an embodiment of the operation the System Integration Object Network through an Object-Oriented Event Driven method. The method can be practiced using the Modular Electronic System of FIG. 1.

FIG. 21 illustrates an embodiment of the Modular Electronic System of FIG. 1 that includes an LCD display with Panel Implant Components.

FIG. 22 illustrates a front view of the embodiment of FIG. 21.

### DETAILED DESCRIPTION

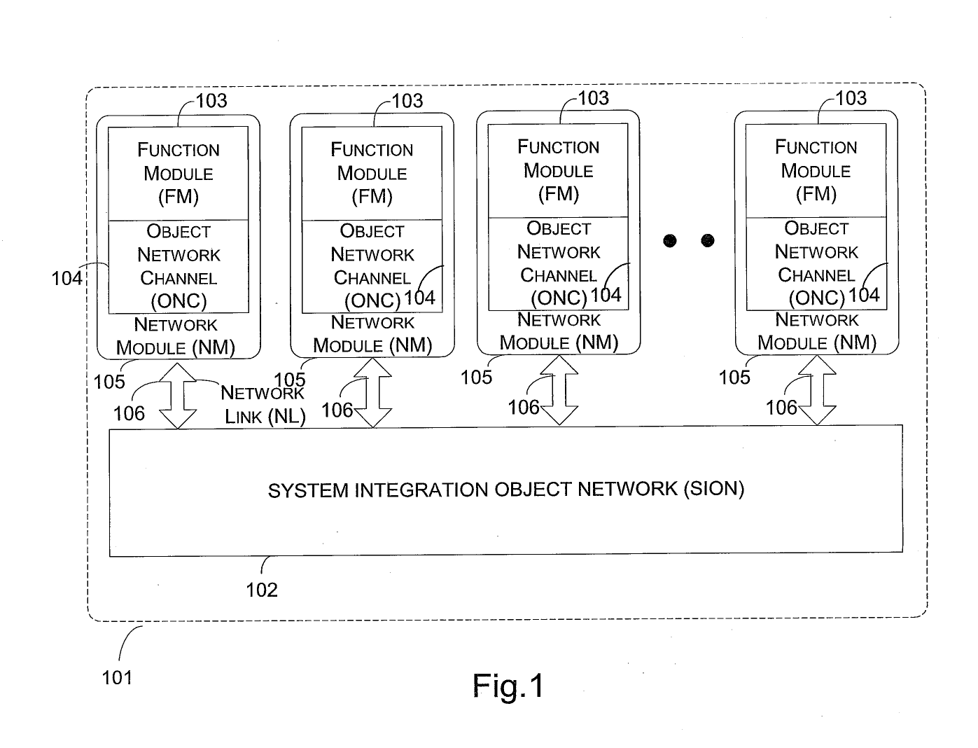

With reference to FIG. 1, a Modular Electronic System 101 in accordance with the present invention is shown. An apparatus and method for making and using a Modular Electronic System 101 based on interconnection networks and replaceable, upgradable or addable modules is herein disclosed. Suitable electronic devices and systems for which the Modular Electronic System 101 may be used include consumer electronics, computer, communication and network devices, smart phones, tablets, smart TVs, various interactive displays, and automobile electronics including entertainment and navigation systems.

A first aspect of the disclosure is directed to a System Integration Object Network 102 (SION) as backbone to dynamically or incrementally build and/or integrate modular electronic systems. The system can start with a bare bone i.e. minimally populated System Integration Object Network 102 and dynamically and/or incrementally plug in Network Modules 105 (NMs) to add, modify and/or adjust the system functions. The System Integration Object Network 102 can be configured to support popular interconnect standards, for example super speed serial links such as USB 3.0.

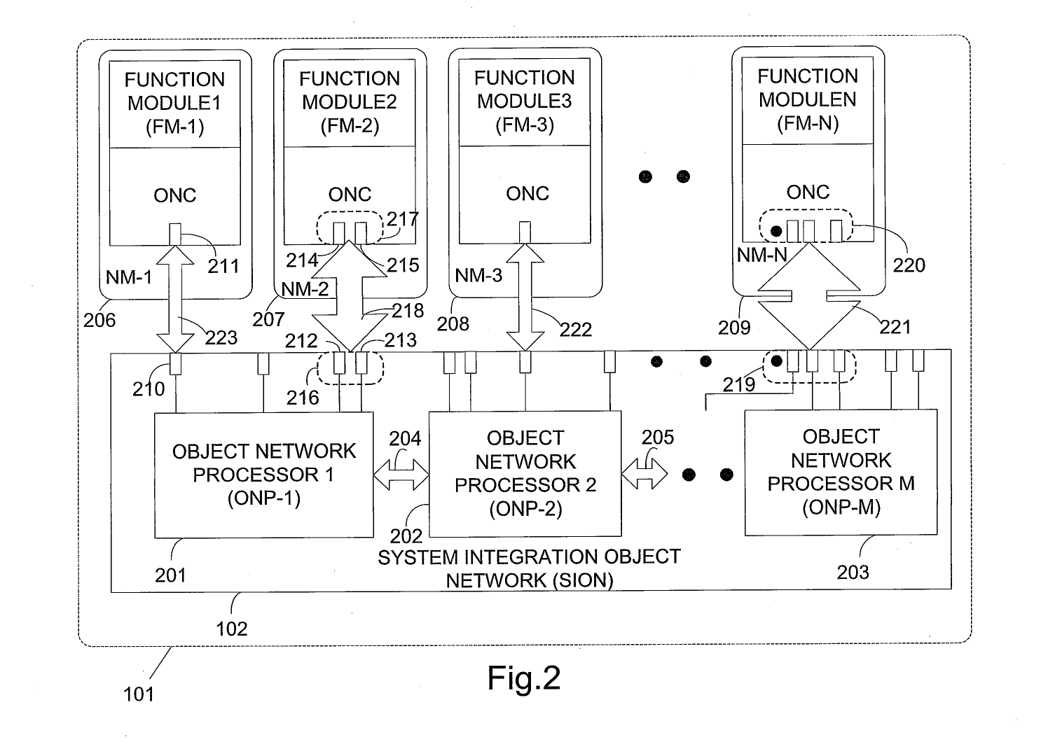

A second aspect is directed to an Object Network Processor (ONP) based system to configure the System Integration Object Network in selected connection structures, such as switching hub structures, or switching router structures, with accordingly selected protocols. The Object Network Processor 201, 202, 203 will be further discussed with reference to FIG. 2.

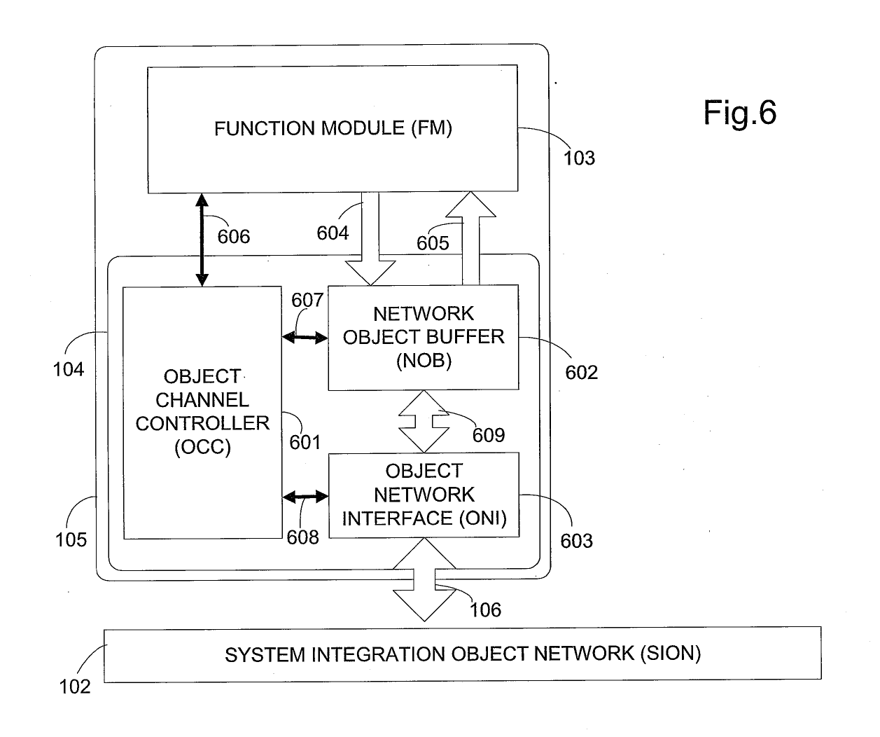

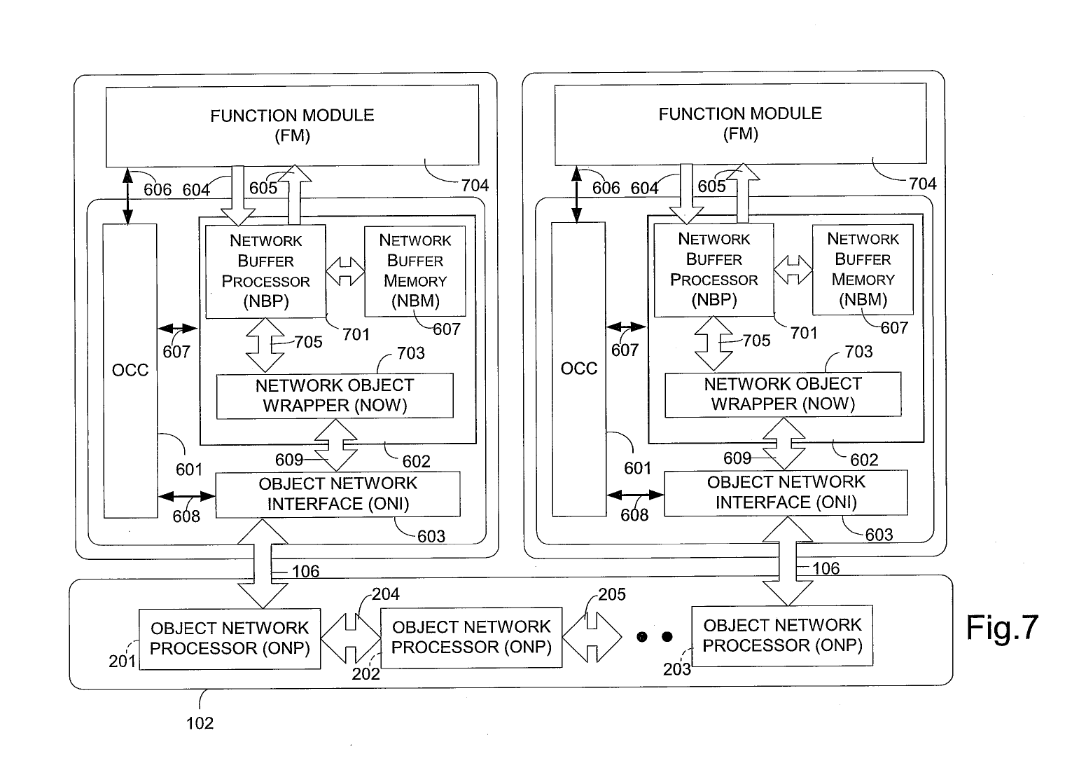

A third aspect is directed to an Adjustable Network Module 105 based on a programmable Object Network Channel 104 (ONC). The programmable Object Network Channel 104 is used to present certain functions to the System Integration Object Network, and could be configured to alter or otherwise adapt the System Integration Object Network for network structure changes such as differing network connections or differing network topologies, or protocol changes or other types of design evolution. An Object Buffer Memory (OBM) to support various application specific object data communication requirements is described. The Object Buffer Memory supports network objects using mass storage memory, for example DRAM, and will be further discussed with reference to FIGS. 6 and 7.

Continuing with FIG. 1, a block diagram shows one embodiment of a Modular Electronic System 101, which includes at least one System Integration Object Network 102. One or more Network Modules 105 can be connected to the System Integration Object Network 102 to add function to the modular electronic system 101. Each Network Module 105 contains a Function Module (FM) 103, and an Object Network Channel 104. Each Function Module 103 performs a specified function for the system, and is connected and presented to the System Integration Object Network 102 through the Object Network Channel 104 and the Network Link 106.

As will be further discussed with reference to FIGS. 2, 7 and 10, the System Integration Object Network 102 is the system integration backbone. Depending upon configuration, the System Integration Object Network 102 can take on or include the structure of a hub, a switching hub, or a switching router. Embodiments of the System Integration Object Network 102 include memory centric switching network and cross bar switch network architectures, or a mixture of the above configurations. A multitude of Network Modules 105 can be added to the system dynamically to realize flexible system functions.

In one embodiment, the Network Link 106 is a serial link, conforming to a standard such as USB 1/2/3 or PCIe 1/2/3, or future generations thereof, or other serial link of a similar nature. In further embodiments, the Network Link 106 is an optical link, such as in the LightPeak specification. In another embodiment, the Network Link 106 is a contactless high speed link such as a capacitively coupled, inductively coupled, or short-distance radio frequency (RF) coupled link.

FIG. 2 shows further detail of an embodiment of the Modular Electronic System 101. A System Integration Object Network 102 is implemented using a plurality of Object Network Processors 201, 202, 203, which are interconnected. In this example, at least three Object Network Processors 201, 202, 203 are connected by network processor connections 204, 205 to form a network having at least 13 ports 212, 213 (others not labeled). The System Integration Object Network 102 can route signals from each port to any other port or ports. In one example, USB 3.0 is used as the standard or basis for the Network Links, and each port 212, 213 can support a single USB 3.0 connection. An example of a standard or single bandwidth connection is shown in the Network Link between the port 210 of the Object Network Processor 201 and the port 211 of the Network Module 206. A further standard or single bandwidth connection is made between the Network Module 3 (NM-3) 208 and the Object Network Processor 2 (ONP-2) 202.

Multiple ports can be bundled together to support higher bandwidth, as Virtual Ports. In FIG. 2, Network Module 2 (NM-2) 207 bundles two ports 214, 217 to form a Virtual Port (VP) 215, which connects to the Virtual Port (VP) 216 formed by bundling the two ports 212, 213 on Object Network Processor 1 (ONP-1) 201 to form a double data rate or double bandwidth Network Link 218. Three ports are bundled together at the Nth Network Module (NM-N) 209 to form a Virtual Port 220 and at the Mth Object Network Processor (ONP-M) 203 to form a Virtual Port 219. A triple data rate or triple bandwidth Network Link 221 is thereby formed. Such bundling is supported for parallel ports as well as for serial ports. Data flows are controlled to combine, separate and otherwise manage the data in such bundling.

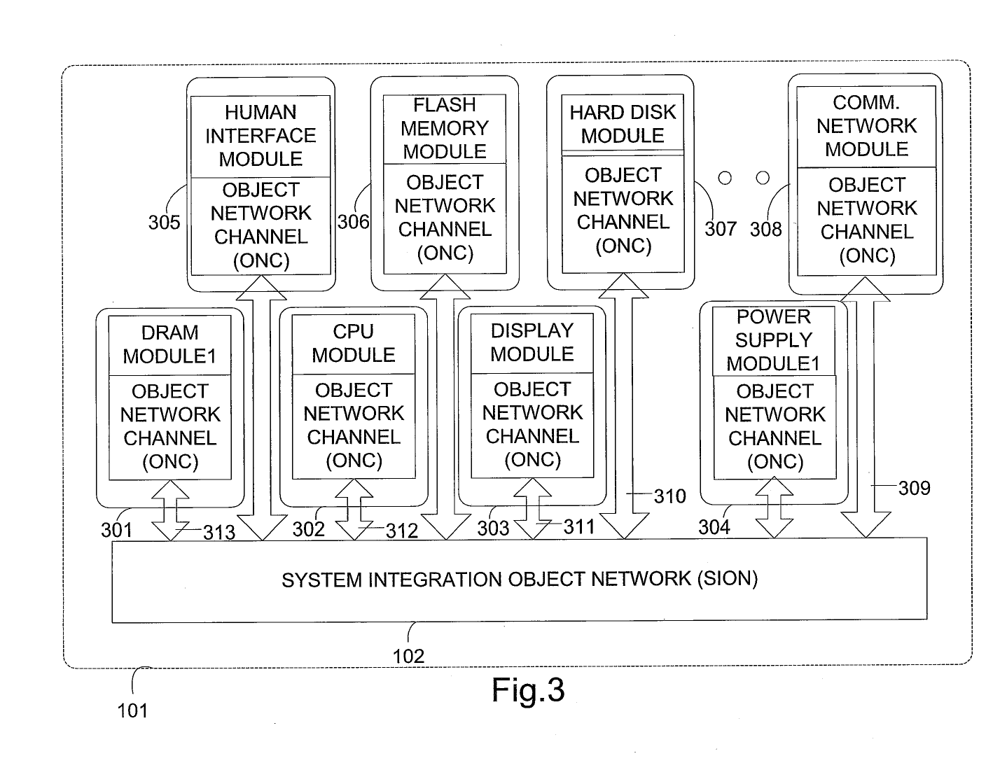

FIG. 3 illustrates a consumer product embodiment of the Modular Electronic System 101. Function Modules, each in a respective Network Module, are added to the System Integration Object Network 102 to form the shown embodiment of the modular electronic system 101. In this example, the Network Modules are named for the respective function modules therein and include, but are not limited to, DRAM Module 301, CPU Module 302, Display Module 303, Power Supply Module 304, Human Interface Module 305, Flash Memory Module 306, Hard Disk Module 307, and Wireless/Wired Communication Network Module 308. In one embodiment, the Human Interface Module 305 includes a camera module as a portion or the entirety of the function module. A further embodiment of the Human Interface Module 305 includes audio modules. Various embodiments of the Wireless/Wired Communication Interface Module 308 include, but are not limited to function modules supporting 3G/4G cellular, WiFi, ZigBee, WiMax for wireless communications, ADSL, Cable Modem, Optical Link such as LightPeak, Gbit Ethernet, Power Plug, 1394 Firewire, HDMI, UART for wired communications and other communication interfaces. In further embodiments, the Display Module 303 includes a connector to a display screen or includes the display screen, and the consumer product is or includes a modular television, video game, video player, personal computer, touchscreen, laptop or tablet computer, or smart phone.

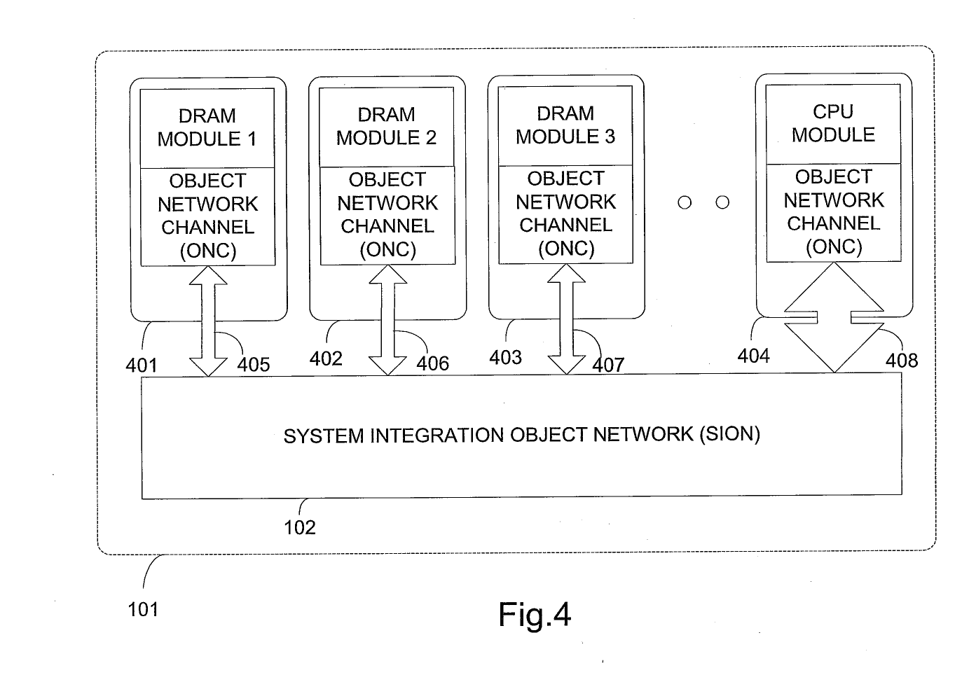

FIG. 4 illustrates an embodiment of the Modular Electronic System 101, having a CPU module 404 and multiple DRAM modules. The DRAM Network Modules 401, 402, 403 are connected to the System Integration Object Network 102 by Network Links 405, 406, 407 and 408 respectively. In one embodiment, each DRAM Network Module includes a respective USB 3.0 port, which could provide a 5.0 Gbps (gigabits per second) data rate through each of the Network Links 405, 406, 407. With three DRAM USB 3.0 modules, the combined aggregate data rate could be 15 Gbps. The CPU Network Module 404 could utilize multiple USB 3.0 links to achieve a 5.0 Gbps×N data rate at its Network Link 408 through bundling N USB 3.0 links together. This type of port and link bundling is further applicable to combined or aggregate data rates and other types of memories and other types of modules.

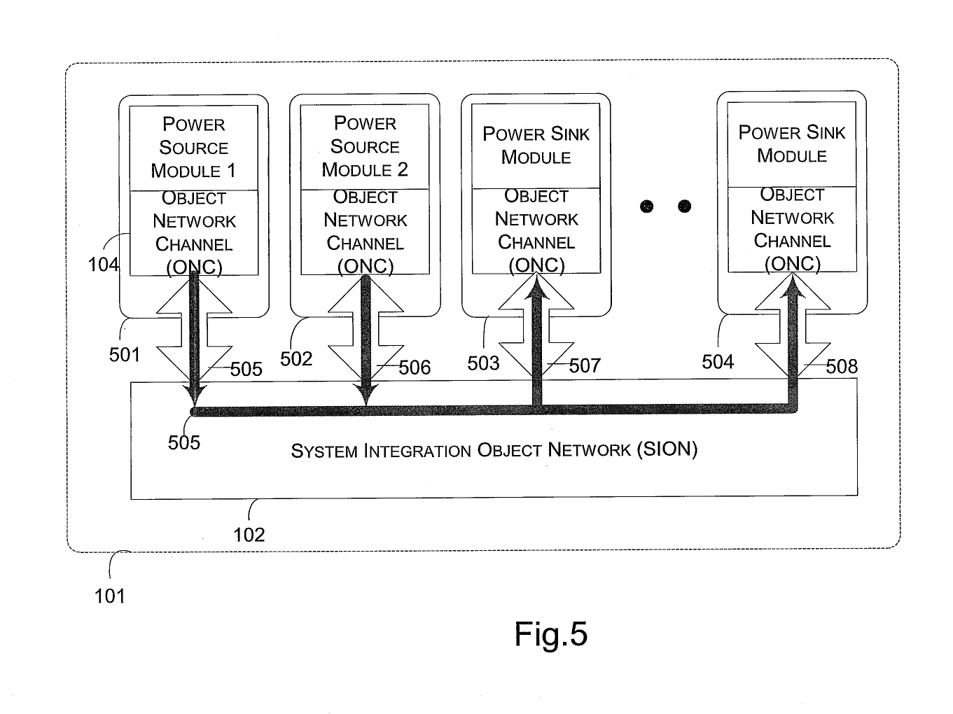

As one embodiment shows in FIG. 5, the System Integration Object Network 102 and Network Links can include power lines and connections. In one embodiment, one or more Network Links are based on USB 3.0, which includes power lines in the link. As shown in FIG. 5, there can be multiple power source modules 501, 502 attached to the system, delivering power through a power bus 505 in the network to power sink modules 503, 504. In one embodiment of this disclosure, the power source module 501, 502 are USB compatible batteries or power supplies, to power the Modular Electronic System 101, which could be included in a cellular phone, a notebook computer, a tablet, or other embodiment disclosed herein.

In the embodiment of a Network Module 105 shown in FIG. 6, the Object Network Channel (ONC) 104 includes an Object Buffer Memory 602, herein depicted as a Network Object Buffer (NOB), an Object Network Interface (ONI) 603, and an Object Channel Controller Controller (OCC) 601. The input signals 605 and output signals 604 for the Function Module (FM) are stored in the Object Buffer Memory 602, which connects to the System Integration Object Network 102 through Object Network Interface 603. The Object Channel Controller 601 controls the data flow to and from the Function Module 103, through or to and from the Object Buffer Memory 602, to and from the Object Network Interface 603, and to and from the System Integration Object Network 102. In various embodiments, the operation of Network Modules 105 in the system can be synchronous or asynchronous. In one embodiment of synchronous operation, the Object Channel Controller 601 includes the function of clock recovery.

In one embodiment, the Function Module 103 sends and/or receives object-oriented data, i.e. data pertaining to an object such as relates to object-oriented programming. In such an embodiment, the Object Buffer Memory 602 acts as a Network Object Buffer, temporarily storing or buffering the data pertaining to the object. In a further embodiment, the Function Module 103 sends and/or receives raw data, and the Object Buffer Memory 602 processes as well as stores the data, to present the data in object-oriented form as suitable for transfer to and from the nearest Object Network Processor, transfer in the System Integration Object Network 102 and use in further modules. Thus, the Object Buffer Memory (OBM) 602 stores and presents the object-oriented data that is transferred through the System Integration Object Network 102.

FIG. 7 shows an embodiment of an Object Buffer Memory 602 communicating with a Function Module 704, an Object Channel Controller 601 and an Object Network Interface 603. The Network Buffer Memory (NBM) 702, which includes a mass storage memory such as DRAM, is used to store the data related to the Function Module 704 for transferring to and from the System Integration Object Network 102. The Network Buffer Processor (NBP) 701 is a programmable memory controller that accesses the Network Buffer Memory 702. The Network Object Wrapper (NOW) 703 is a data/object converter. The Network Object Wrapper 703 in one embodiment converts raw data from and to the Function Module 704 to and from object-oriented data, which is then shuttled by the Network Buffer Processor to and from the Network Buffer Memory 702 and to and from the Object Network Interface 603, under control of the object Channel controller 601. In a further embodiment, the Network Object Wrapper 703 cooperates with the Network Buffer Processor 701 to repackage raw data in the Network Buffer Memory into object-oriented data. This conversion of raw data to object-oriented data may involve identifying groups of data that correspond to an object or may involve establishing links between groups of data corresponding to linked objects and others tasks associated with object-oriented programming. Similarly, a conversion from object-oriented data to raw data, if such is used in a Function Module, may involve inverse operations such as extracting sections of data from object-oriented data. These operations may be handled in hardware, software or firmware or a mixture thereof. Object-oriented data is then presentable to the Object Network Processors 201, which configure and process the network object flows in the System Integration Object Network 102. In one embodiment, the Network Object Wrapper 703 converts raw data to and from an object type acceptable by the Object Network Processor 201, and adds meta-data such as ID, security, power, performance measure and one or more dependency fields.

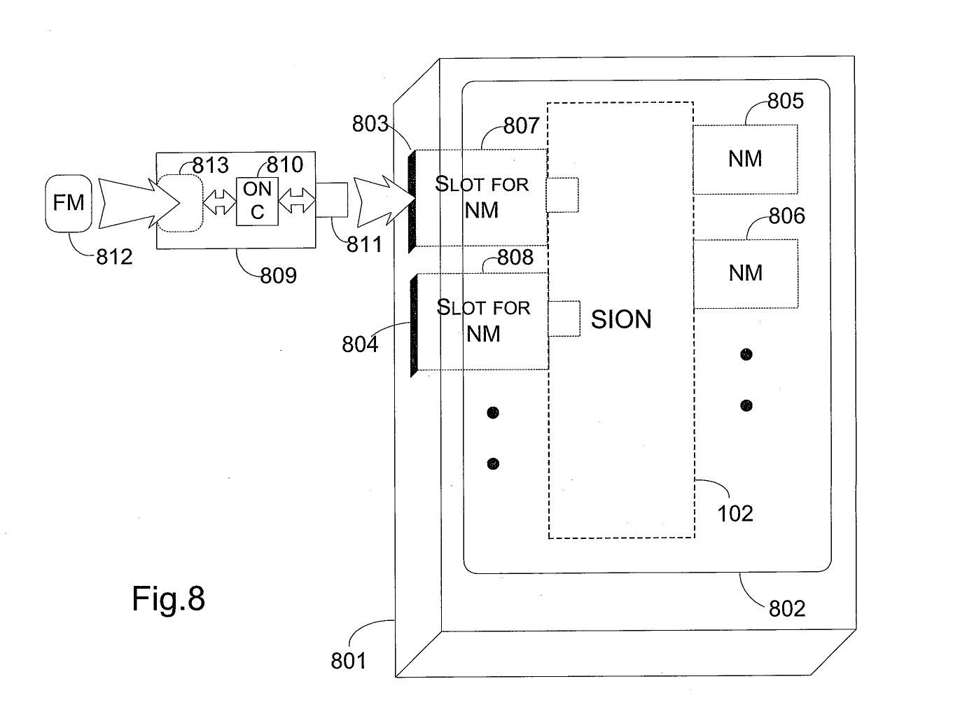

FIG. 8 shows an embodiment of the Modular Electronic System 101 in a modular display system 801, which includes a display 802. Inside or integrated with the display system 801 is a System Integration Object Network 102 with a variable number of internal Network Modules 805, 806. The display system 802 includes a variable number of slots 807, 808 to plug in one or more embodiments of the external Network Module 809. In one embodiment, the external Network Module 809 is implemented as a device carrier which includes a built in Object Network Channel 810, which could be in IC chip or SiP (System in Package) form. In one embodiment, the Function Module 813 includes a daughter device carrier 812 which can be plugged into the Network Module 809. The Network Module 809 includes a connection port 811 to the port in the System Integration Object Network 102. In one embodiment of this disclosure shown here, the connection port 811 is a USB 3.0 port. Depending on the size of the display and the functions of the network modules, various systems can be implemented from the basic structure of the display system 801, including portable display pads, smart phones, smart TVs, application specific smart displays, etc. Although the USB 3.0 port is shown as example, in further embodiments the port can be realized in other communication data link standards.

With reference to FIGS. 1-8, in various embodiments the Modular Electronic System 101, the System Integration Object Network 102, and/or one or more Network Modules (NM) 105, can be implemented using NoC (Network on Chip), NiP (Network in Package), NoPCB (Network on PCB), and/or NiB (Network in a Box) forms and technology. Various components of the network can be in IP forms (for NoC integration), in KGD (Known Good Die) forms (for NiP integration), or in discrete IC forms (for NiB integration). In one embodiment, the Network in a Box (NiB) form is a major form for delivering smart phones, PDAs, tablets, smart TVs, modular PCs. In another embodiment, the Network on a PCB (NoPCB) or Network in Package (NiP) are major forms for delivering the system to embedded applications, such as automobile, aero space, machinery, or industrial equipment applications.

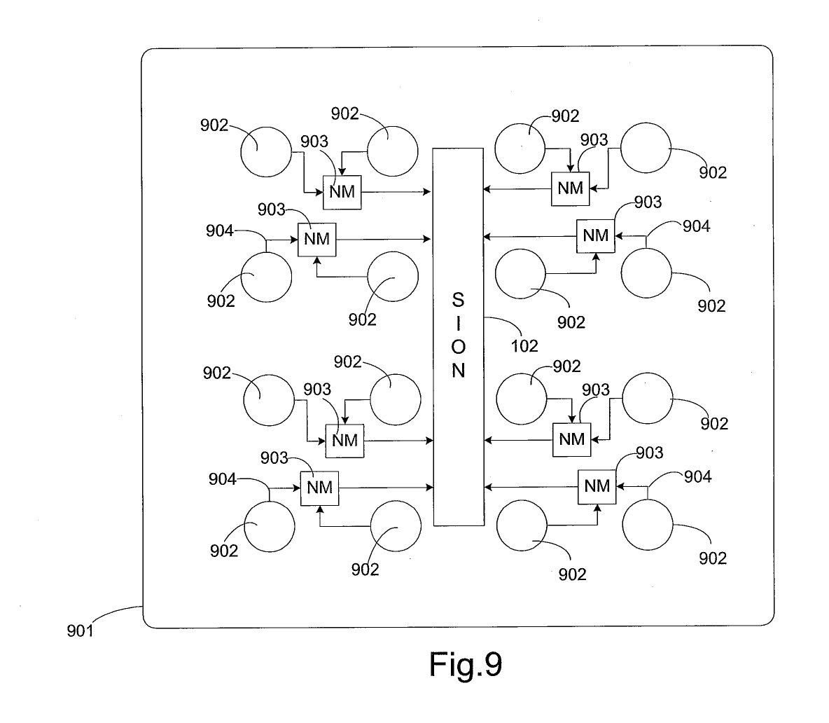

FIG. 9 shows a display device 901 in which human interface devices 902 such as sensors or actuators are embedded, in an embodiment of a Modular Electronic System. The human interface devices 902 are connected to Network Modules 903, which are connected in turn to a System Integration Object Network 102. In the embodiment shown, to human interface devices 902 are connected to each of the network modules 903, and further embodiments may have fewer or more human interface devices or a mixture of human interface devices so connected. The human interface devices can include sensors such as light sensors, infrared sensors, cameras, ultrasonic detectors e.g. sonar rangefinders and motion detectors, audio sensors such as microphones, transducers, etc. The human interface devices can include emitters such as light emitters e.g. laser or LED, infrared emitters for lighting as sensed by an infrared camera or for communication as sensed by an infrared receiving device, audio emitters such as audio speakers, ultrasonic transducers, etc. Embedded human interface devices 902 in a display device 901 in one embodiment is an interactive television, and in further embodiments is an interactive personal computer, tablet, game device, smart phone, or portable interactive computer.

In one embodiment, the display device 901 is an LCD (liquid crystal display) panel, onto or into which a plurality of interconnection traces for the Network Links 904 are deposited. In one embodiment, the System Integration Object Network and/or the Network Modules in IC die or packaged form are mounted onto the interconnection traces deposited on or in the display device 901. In a further embodiment, the human interface devices 902 include an array of image sensors which can capture multi-dimensional light field information. In a still further embodiment, properties of the LCD at each human interface device location can be adjusted by TFT (thin-film transistor) circuits in combination with the sensors/actuators to sense/generate different effects for human perception.

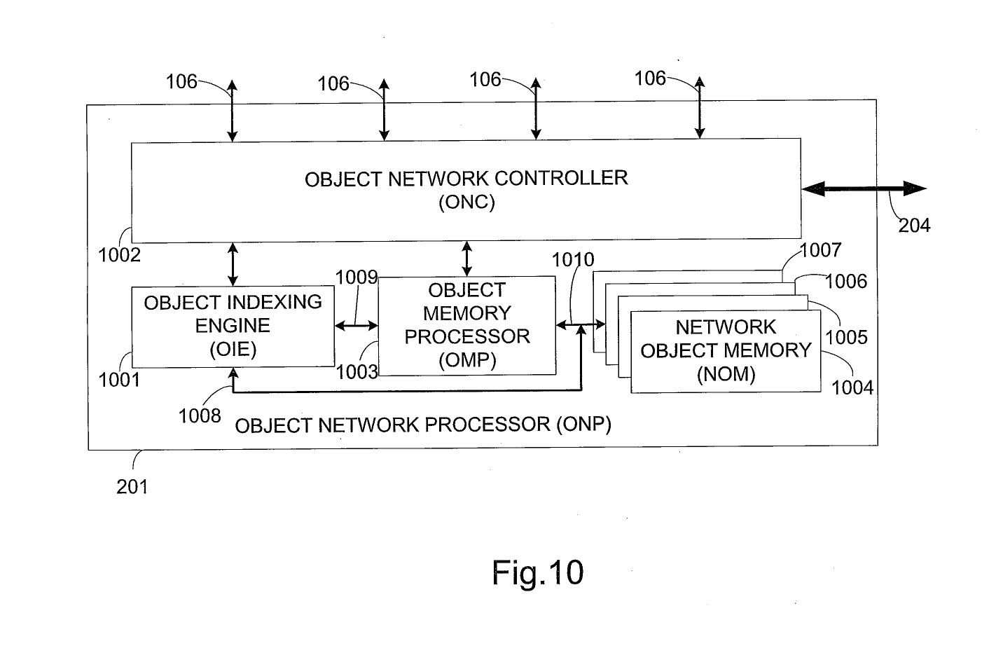

FIG. 10 shows one embodiment of an Object Network Processor 201, which is connectable to one or more further Object Network Processors to form a System Integration Object Network. In the Object Network Processor 201, an Object Network Controller 1002 is communicating with a respective one or more of the network modules via a respective one or more serial or parallel interfaces, as shown in FIG. 2. Further, the Object Network Processor 201 includes an Object Indexing Engine (OIE) 1001, an Object Memory Processor (OMP) 1003, and Network Object Memory (NOM) 1004, 1005, 1006, 1007, which are interconnected. The Object Indexing Engine 1001 and the Object Memory Processor 1003 are connected to the Object Network Controller 1002. The Object Network Controller 1002 is a type of data switch, and can switch data among various ports. The data switch, in this embodiment the Object Network controller 1002, and the Object Indexing Engine 1001 and the Object Memory Processor 1003 are configured to move data associated with an object i.e. object-oriented data among the network modules, the data switch, the local memory (designated in this embodiment as Network Object Memory) and neighboring Object Network Processors. In one embodiment, this is accomplished in part by using the Network Object Memory 1004 as a type of mailbox for deposit and retrieval of object-oriented data. Data flow is under control of the Object Indexing Engine 1001, which tracks object-oriented data, the Object Memory Processor 1003, which assigns and tracks memory locations in the Network Object Memory 1004, 1005, 1006, 1007 for the object-oriented data, and the Object Network Controller 1002 which switches data to and from the respective Network Module or Modules, to and from neighboring one or ones of the Object Network Processors and to and from the Network Object Memory 1004, 1005, 1006, 1007 via the Object Indexing Engine 1001 and the Object Memory Processor 1003.

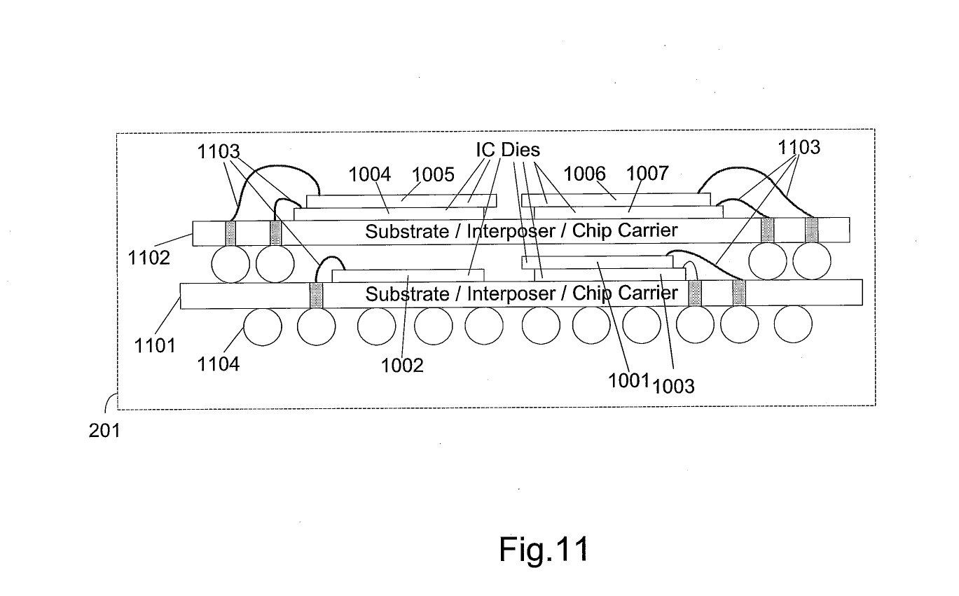

FIG. 11 shows an embodiment of a portion of the Modular Electronic System, namely the Object Network Processor 201, which is densely packaged using three-dimensional die packaging technology. Integrated circuit dies (or dice) implementing the Object Network Controller 1002, the Object Memory Processor 1003, the Network Object Memory 1004, and a further Network Object Memory 1007 are mounted to substrate carriers 1101, 1102, which act as miniature printed circuit boards and have signal routing therein. Further dies implementing the Object Indexing Engine 1001, a Network Object Memory 1005, and a further Network Object Memory 1006 are stacked upon some of the dies using die stacking technology. Wire bonds 1103 connect from pads of the dies to the substrate carriers 1101, 1102, or may be used for die to die connection of die pads. Vias through the substrate carriers 1101, 1102, and solder ball technology can be used to connect signals between dies on one of the substrate carriers and dies on another of the substrate carriers. In further embodiments, further portions or the entirety of the Modular Electronic System can be so packaged, or differing arrangements of the dies can be so packaged.

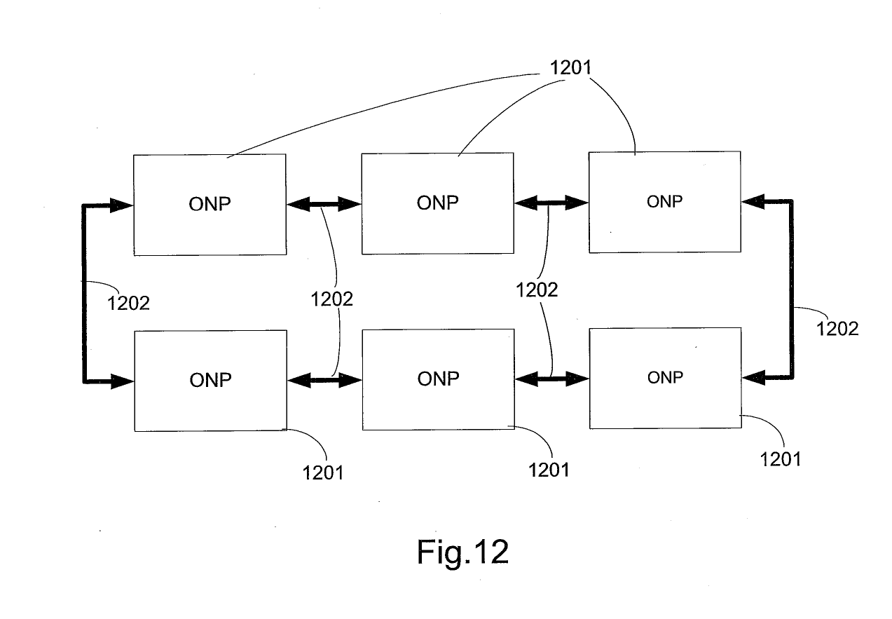

FIG. 12 shows an embodiment of the System Integration Object Network connected as a ring network. Object Network Processors 1201 have neighboring network connections 1202 exhibiting a ring topology.

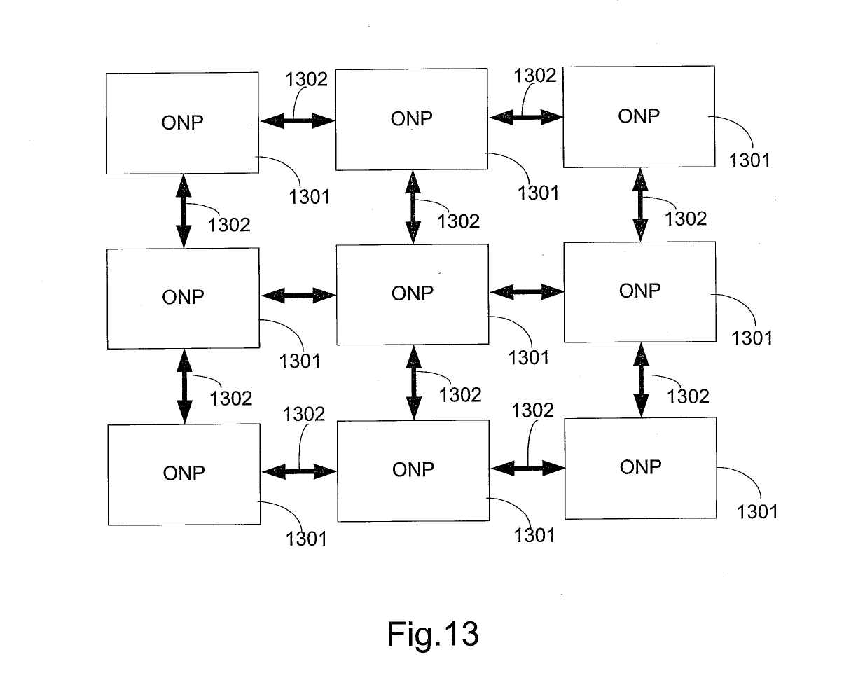

FIG. 13 shows an embodiment of the System Integration Object Network connected as a mesh network. Object Network Processors 1301 have neighboring network connections 1302 exhibiting a mesh topology.

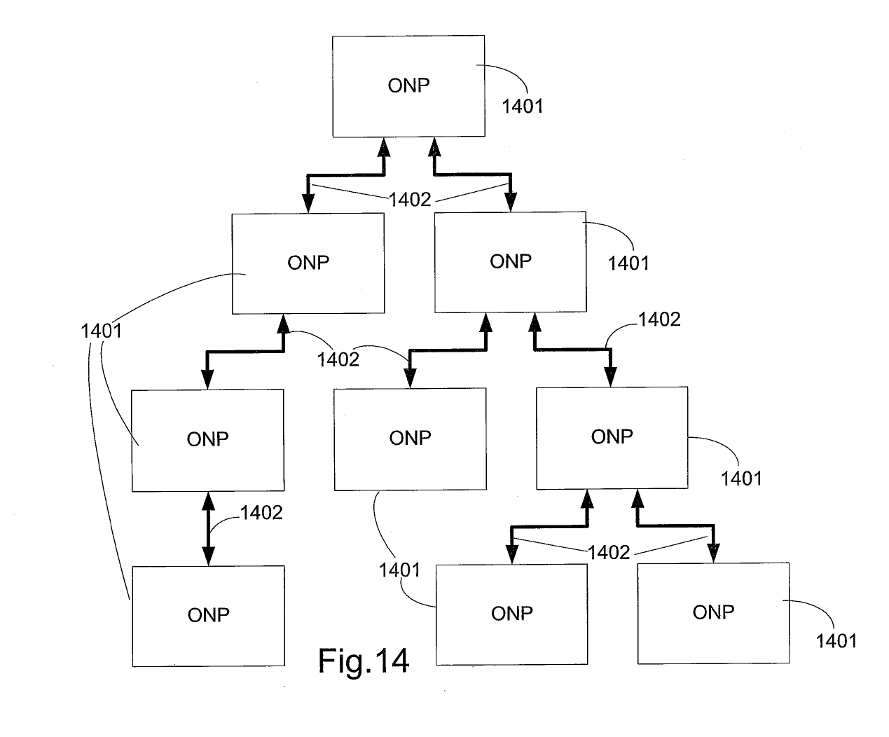

FIG. 14 shows an embodiment of the System Integration Object Network connected as a tree network. Object Network Processors 1401 have neighboring network connections 1402 exhibiting a tree topology.

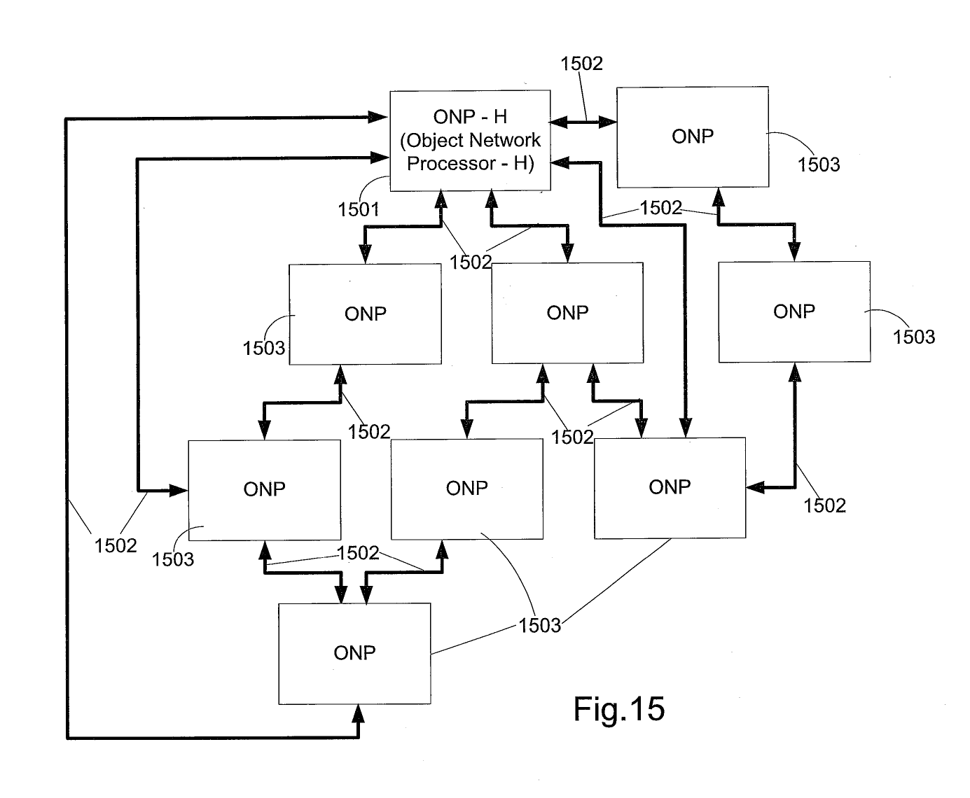

FIG. 15 shows an embodiment of the System Integration Object Network connected as a general graph with hub-and-spoke hotspots. Object Network Processors 1501 have neighboring network connections 1502 exhibiting a hub-and-spoke topology, in which Object Network Processor-H is a hotspot.

As seen in FIGS. 12-15, various network topologies are possible in connections of the Object Network Processors in a System Integration Object Network. FIG. 12 shows a ring topology. Further network topologies, including chain, ring, tree, mesh or hub-and-spoke, are readily devised and applied in connections of the Object Network Processors in a System Integration Object Network.

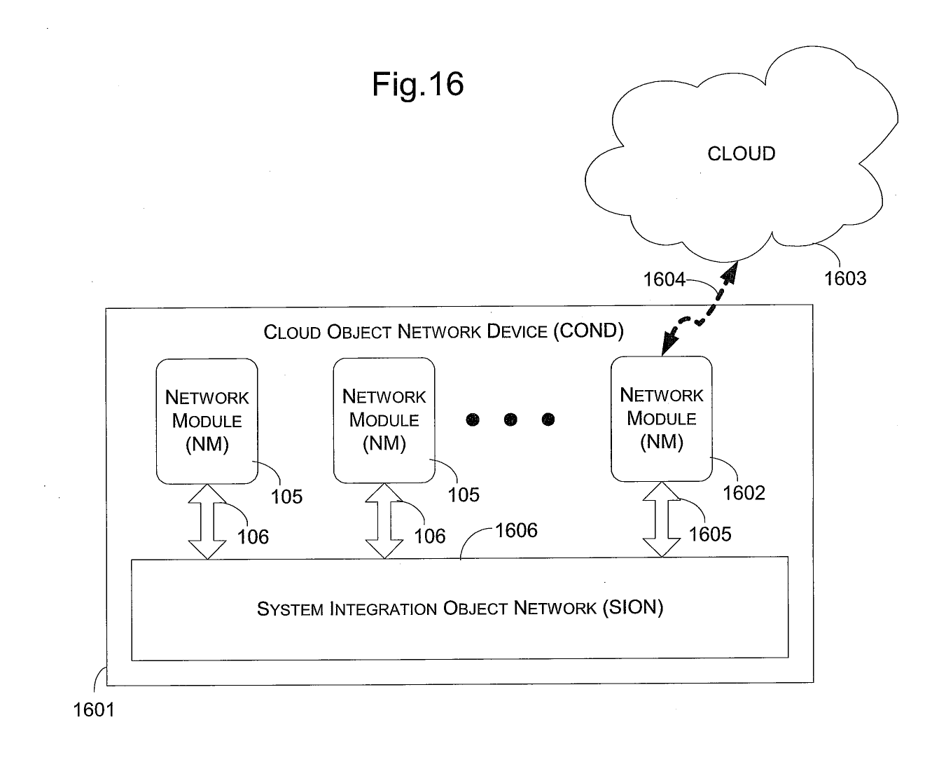

FIG. 16 shows a Cloud Object Network Device (COND) 1601 as an embodiment of the Modular Electronic System. A plurality of Network Modules 1602 are connected to a System Integration Object Network 1606 by respective Network Links 1605. An Internet connection 1604 connects to the Internet “cloud” 1603. One of the capabilities such an embodiment affords is that one or more of the Network Modules 1602, and/or one or more of the Network Modules (not shown in FIG. 16 but see FIG. 1) in the System Integration Object Network 1606 can be configured, updated, reconfigured or otherwise altered via the Internet connection. A further capability is that object-oriented data can be provided to or from one or more of the Network Modules 1602 via the Internet connection. Utilizing the hardware and software capabilities of the Network Modules, the Cloud Object Network Device 1601 can present selected cloud services through object-on-demand from the cloud 1603. The cloud services can include life cycle management for the function modules. Further embodiments have further connections to further types of networks.

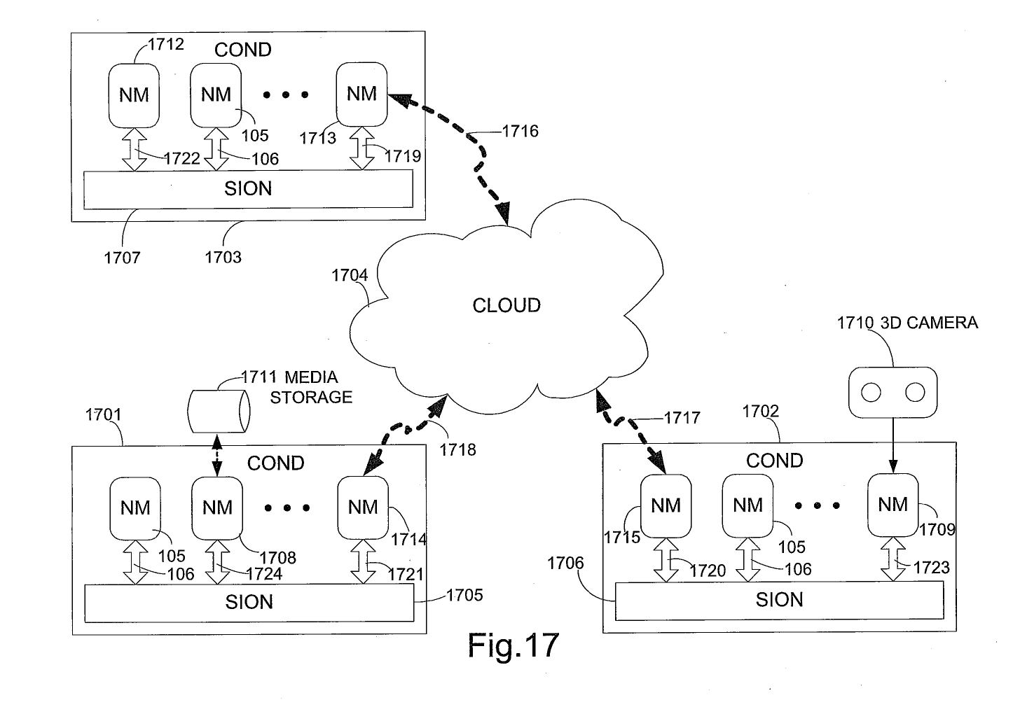

FIG. 17 shows multiple embodiments of the Cloud Object Network Device 1601 as a virtual system connected through the Internet cloud 1704. Three embodiments of the Modular Electronic System 1701, 1702, 1703 have respective Internet connections 1718, 1717, 1716 to the Internet cloud 1704. Modular Electronic System 1701 includes a Network Module 1708 communicating with a storage module 1711 and a Network Module 1714 communicating via the Internet connection 1718, with the Network Modules connected to the System Integration Object Network 1705. The storage module 1711 can be, for example a media storage or a mass storage. Modular Electronic System 1702 includes a Network Module 1715 communicating via the Internet connection 1717 and a Network Module 1709 communicating with a 3-D camera 1710 such as a stereo vision camera or a 3-D surveillance camera, with the Network Modules connected to the System Integration Object Network 1706. Modular Electronic System 1703 includes a Network Module 1713 communicating via the Internet connection 1716 and a further Network Module 1712, with the Network Modules connected to the System Integration Object Network 1705. Further Network Modules may be included in any or all of the embodiments. The Network Module 1712 in the Modular Electronic System 1703 can share the 3-D camera 1710 and/or the storage module 1711. The Network Module 1712 or a further Network Module on a differing Modular Electronic System can control the 3-D camera 1710 and/or access a stored. video stream on the storage module 1711. Further examples and types of shared access are readily devised using the teachings herein.

FIG. 17 further shows how to achieve hierarchical or nested connectivity of the Modular Electronic System. Connecting a Network Module of one Cloud Object Network Device to a further Network Module of a further Cloud Object Network Device, via respective Internet connections and the cloud 1704 can create virtual modules with hierarchical or nested connectivity. For example, connecting the network module 1714 of the Cloud Object Network Device 1701 to the Network Module 1713 of the Cloud Object Network Device 1703 can cause the entire Cloud Object Network Device 1701 to be seen as a virtual Network Module connected to the System Integration Object Network 1707 in the Cloud Object Network Device 1703. Further examples of multi-level hierarchical and nested Cloud Object Network Devices and virtual Network Modules are readily devised using the teachings herein.

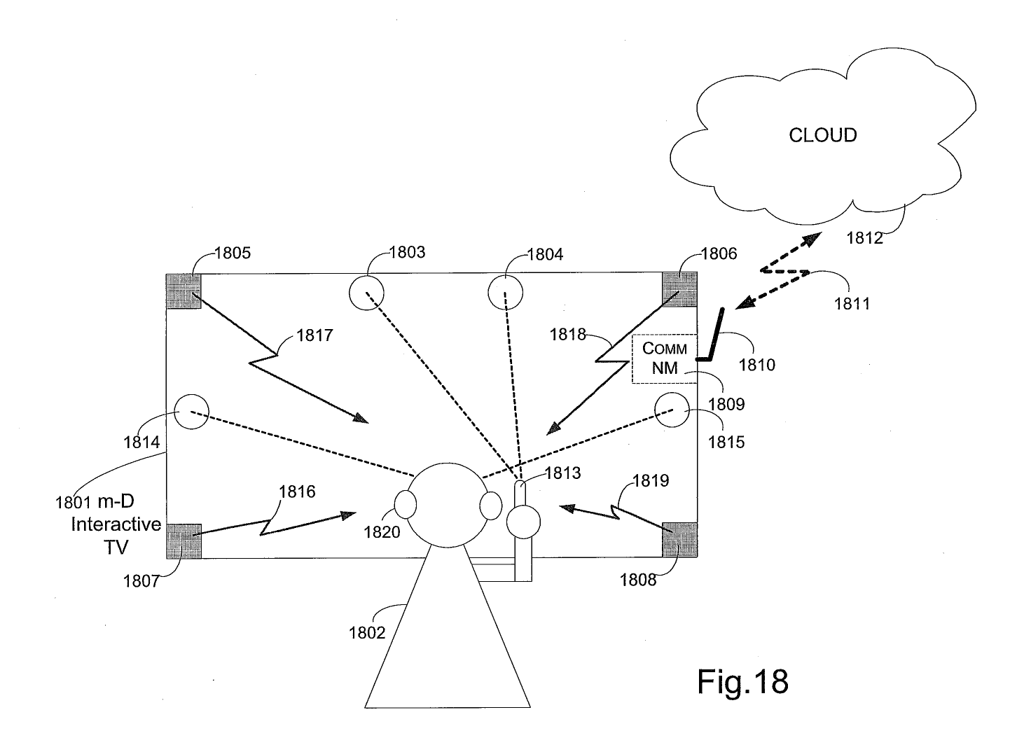

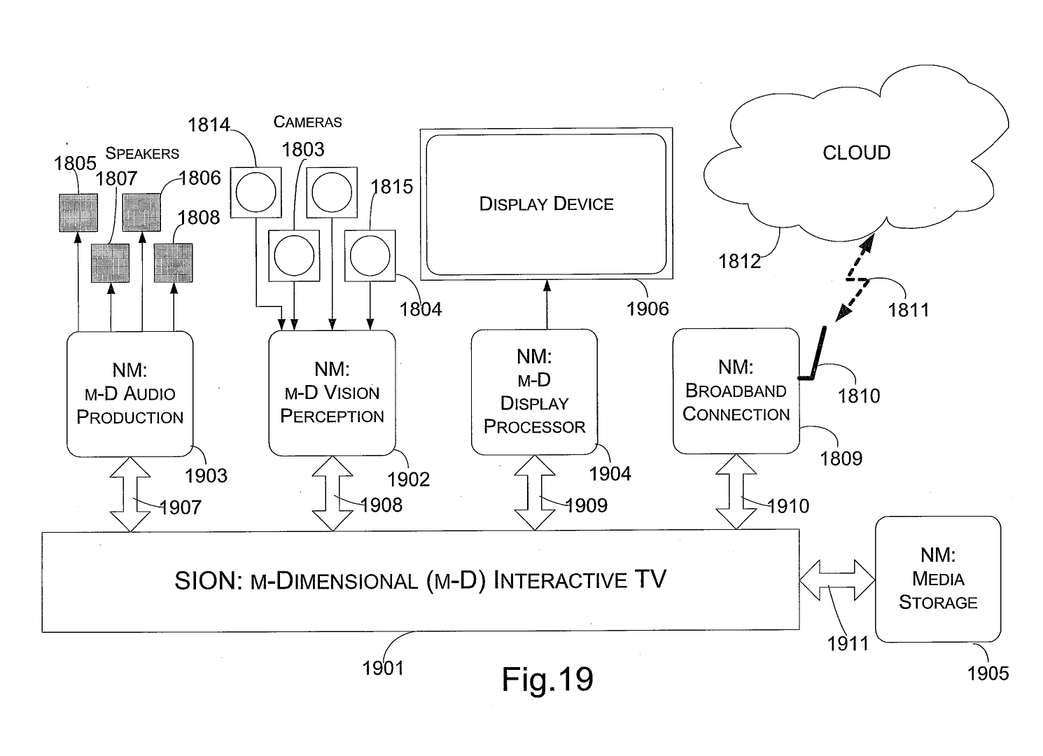

FIG. 18 shows and interactive television 1801 as an embodiment of the Modular Electronic System, featuring embedded sensors and actuators as symbolically depicted in FIG. 9. Further such embodiments include interactive computers, interactive videogame systems and full immersion interactive virtual reality systems. The interactive television 1801 has a large video display occupying a majority of the front surface of the interactive television 1801. Embedded in the interactive television 1801 are a plurality or an array of video cameras 1801, 1803, 1814, 1815, which can be other types of subject detecting and tracking units in other embodiments. Further embedded in the interactive television 1801 are a plurality of audio speakers 1805, 1806, 1807, 1808. Internal connections in the Modular Electronic System relating to the interactive television 1801 will be discussed with reference to FIG. 19.

Continuing with FIG. 18, an antenna 1810 connected to a wireless communication Network Module 1809 provides a wireless connection 1811 to the Internet cloud 1812. A person 1802 positioned in front of the interactive television 1801 provide a subject for the video cameras and a target for the audio speakers. Processing within the Modular Electronic System provides an interactive experience for the person 1802. For example, two of the cameras 1814, 1815 can recognize or perceive as a subject the person 1802 or even the individual eyes of the person 1802, and can track these with full depth perception and three-dimensional coordinates. Images on the display screen of the interactive television 1801 can be adjusted according to the tracking of the person 1802 or the eyes of the person 1802. In one embodiment, the display screen is a 3-D screen, using 3-D glasses or glasses-free technology, and 3-D images are personalized and projected in accordance with the tracking of the eyes of the person 1802. In one embodiment, two of the cameras 1803, 1804 recognize or perceive a finger 1813 or hand gestures of the person 1802, and three-dimensionally track these. Such finger or hand gestures can then be used to initiate actions as displayed on the screen, or can be used for direction of video content or selection e.g. channel changing, volume adjustment, web surfing, videogame control, avatar direction, three-dimensional manipulation of scientific visualization databases and so on. In one embodiment, such two-dimensional or three-dimensional tracking of a hand gesture or other body gesture is applied as a replacement of a touchscreen control for touchless control of a system having a display device. Applicable systems include televisions, tablets, smart phones, notebook computers, GPS (global positioning satellite) navigation systems, ATMs (automatic teller machines), information kiosks and so on. In one embodiment, the person 1802 is tracked and the sound is adjusted so as to project audio imaging 1817, 1818, 1816, 1819 from the audio speakers 1805, 1806, 1807, 1808 in accordance with the three-dimensional positioning of the person 1802. In a further embodiment, the ears 1820 of the person are tracked, and the sound is adjusted accordingly.

FIG. 19 shows details of the Modular Electronic System in an embodiment of the interactive television 1801. The audio speakers 1805, 1806, 1807, 1808 are connected to the Network Module 1903, which includes a Function Module performing audio production and is thus an Audio Production Network Module. The video cameras 1803, 1804, 1814, 1815 are connected to the Network Module 1902, which includes a Function Module performing vision perception and is thus a Vision Perception Network Module. A display 1906 is connected to the Network Module 1904, which includes a Function Module acting as a display processor and is thus a Display Processor Network Module. The antenna 1810 is connected to the Network Module 1809, which includes a Function Module providing functions for a broadband connection and is thus a Broadband Connection Network Module. A further Network Module 1905 includes media storage and is thus a Media Storage Network Module. The Network Modules are connected to the System Integration Object Network 1901. In a further embodiment, other types of modules and network connections are provided, such as a wired connection to the Internet or a connection to an intranet.

In the embodiment shown in FIG. 19, the phrase “M-Dimensional” (M-D) is applied to the Audio Production Network Module 1903, the Vision Perception Network Module 1902, the Display Processor Network Module 1904 and the name of the embodiment as M-Dimensional Interactive TV. The phrase is used to mean more than three-dimensional as commonly applied to three-dimensional television, as the M-Dimensional Interactive TV provides three-dimensional tracking of multiple subjects, projected audio tailored to the three dimensionally tracked position of a person or even of the ears of a person, and three-dimensional interactive images responsive to the three dimensionally tracked position of a person or of the gestures of a person.

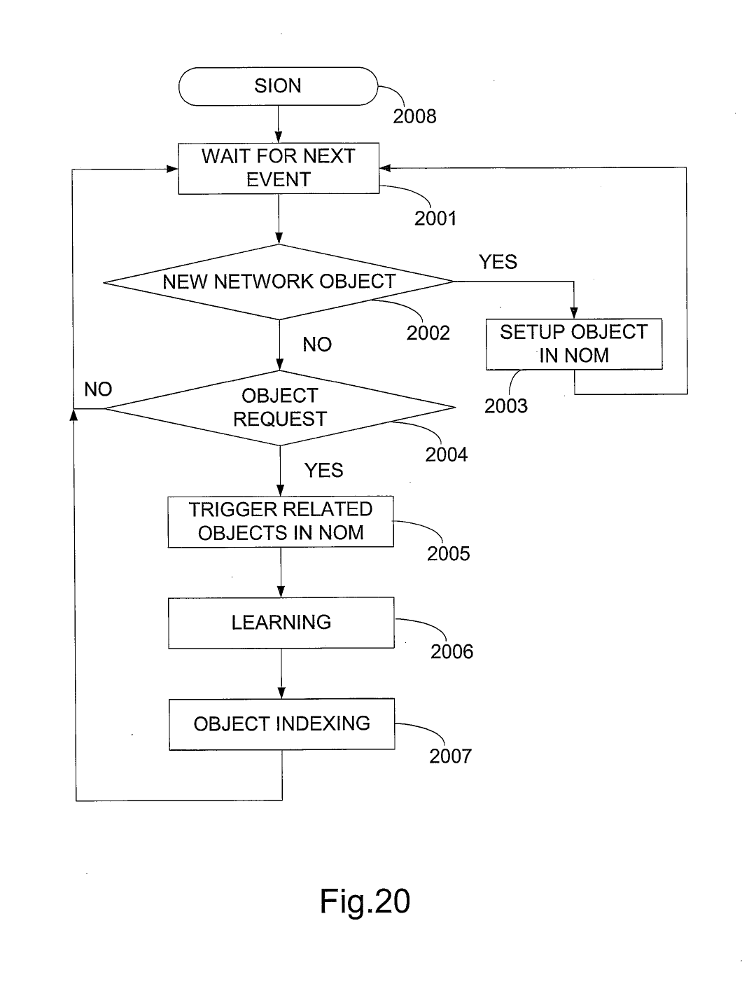

FIG. 20 shows a method of operation for the Modular Electronic System, in which object events drive the operation process. As described above, object-oriented data has origins, destinations and processing in the various Network Modules, specifically in the Function Modules therein. Object-oriented data is exchanged among the Network Modules by the System Integration Object Network. An object is a well-defined entity that has object-oriented data associated with it. The object-oriented data can be transferred through the network and operated upon. Examples of an object include a video stream, an audio stream, an audio production request, a control sequence, a three-dimensional tracking sequence and so on.

Referring to FIG. 7, objects are initiated from a Function Module as data and/or control signals related to the I/O (input/output) of that Function Module. The data is accessed by the Network Buffer Processor 701 and temporarily stored in a specified data format in the Network Buffer Memory 702. The data is then converted into object-oriented data forms which are exchangeable in the System Integration Object Network through the Network Object Wrapper.

Referring to FIG. 2, for example when Network Module-1 206 is sending object-oriented data to Network Module-2 207, through the Object Network Processor-1 201, the Network Module-1 206 triggers an object request in the Object Network Processor-1 201. Referring to FIGS. 2 and 10, when the Object Network Processor-1 201 receives such an object request to route an object, i.e. route the object-oriented data associated with the object, to the Network Module-2 207, the Object Network Processor-1 201 stores the routed object-oriented data in a selected location in the Network Object Memory 1004, 1005, 1006, 1007 associated with the Object Network Processor-1 201, then forwards the object-oriented data to the Network Module-2 207. The Object Memory Processor 1003 is responsible for accessing objects, i.e. object-oriented data, in the Network Object Memory and a routing through the Object Network Controller 1002 to the Network Module connected to the Object Network Processor-1 201, or to another Object Network Processor. The Object Indexing Engine 1001 establishes indexes in the Network Object Memory. In one embodiment, the Object Indexing Engine 1001 improves access performance and quality by applying a learning method.

Returning to FIG. 20, each Object Network Processor 201 in a System Integration Object Network 102 is driven by object events. In an entry block 2008, the System Integration Object Network enters a process and proceeds to a block 2001. In a block 2001, the system and the processor wait for an event, i.e. an object-oriented event. In a block 2002, the question is asked, “is there a new network object?” When there is a new network object, for example a new Network Module including a new Function Module is connected to the System Integration Object Network, appearing to an Object Network Processor, the answer to the question asked in the block 2002 is “yes”, and flow proceeds to the block 2003. In a block 2003, when the answer is yes, there is a new network object, the object is set up in the Network Object Memory. This involves setting up the data structure related to the object, in the Network Object Memory. Such a data structure will hold the object-oriented data. Upon completion of this task, the flow proceeds to the block 2001. If the answer to the question asked in the block 2002 is “no”, there is no new network object, flow proceeds to the block 2004, and the question is asked, “is there an object request?” When a Function Module wants to transmit object-oriented data to another Function Module in the system, this is represented as an object request. An object request triggers related objects in the Network Object Memory. If the answer to the question asked in the block 2004 is “no”, there is no object requests and flow returns to the block 2001 to wait for the next event. If the answer to the question asked in a block 2004 is “yes”, there is an object request and flow proceeds to a block 2005. In a block 2005, the object request triggers related objects in the Network Object Memory. As the system takes actions to handle triggered objects and handle the object-oriented data associated therewith, the system collects statistics of the effects of such data transfers, locations and triggerings, and heuristically improves performance and quality for subsequent operations. Such heuristic improvement includes object indexing, which improves the links between the objects in the Network Object Memory and improves object access time. This is shown in the flow diagram has flowing from the block 2005 to the block 2006, in which learning takes place, followed by flow to the block 2007 in which object indexing takes place. After this, flow returns to the block 2001 to wait for the next event. In one embodiment, the network configuration scheme, including the information about network modules connected to a System Integration Object Network and the network topology are represented i.e. coded using XML or similar languages in the Network Object Memory.

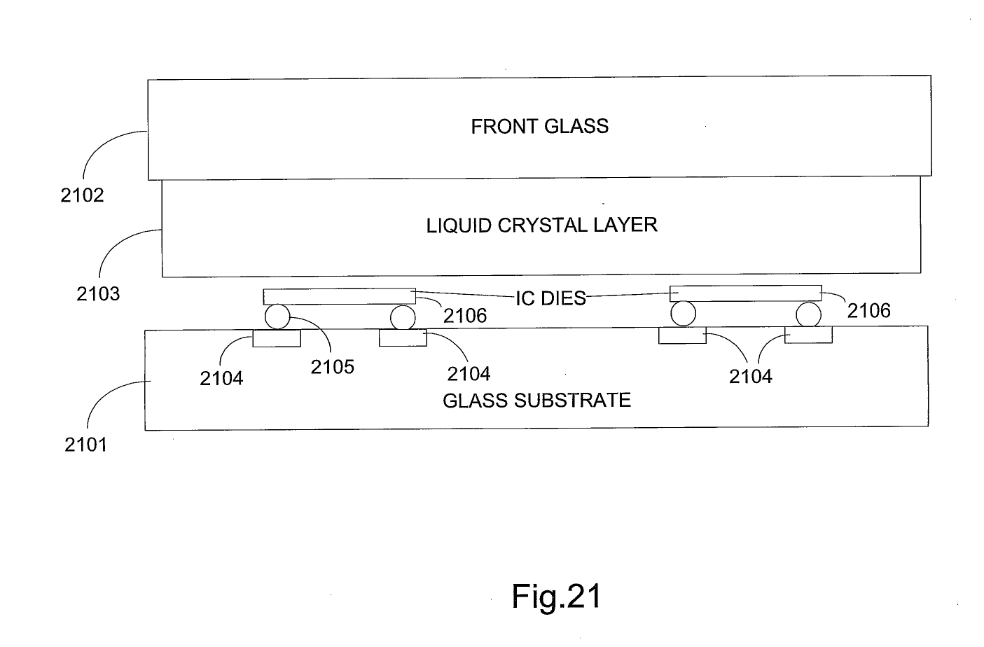

FIG. 21 shows an embodiment of the Modular Electronic System as integrated into an LCD (liquid crystal display) panel. Portions or all of the Modular Electronic System, such as individual Network Modules or the System Integration Object Network are shown as Panel Implant Components (PICs) 2106. The Panel Implant Components 2106 are connected to interconnection lines 2104 which are deposited on the glass substrate 2101. The liquid crystal display panel includes the glass substrate 2101, liquid crystal material 2103 and front glass 2102. In order to avoid blocking a large amount of light transmission, the majority of the panel implant components 2106 can be arranged on the sides of the LCD panel, and arrays of small light sensor Panel Implant Components 2106 can be arranged inside the active display area.

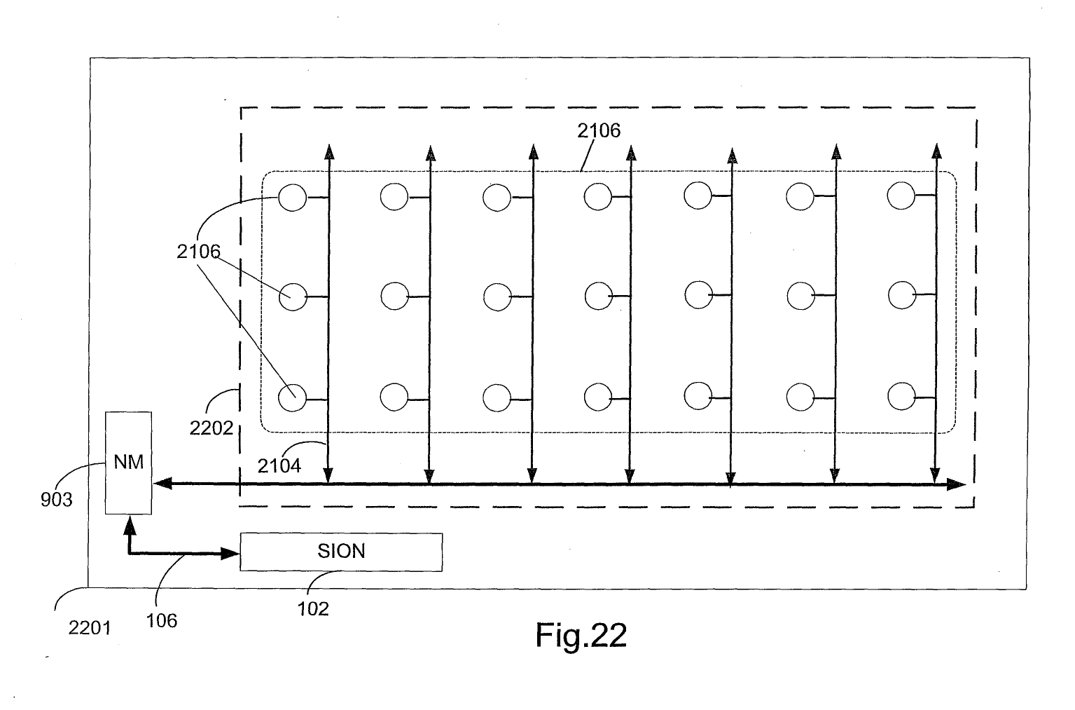

FIG. 22 shows an embodiment of the Modular Electronic System as integrated into the LCD panel 2201. The Network Module 903 and System Integration Object Network 102 are implemented as Panel Implant Components to the sides of the active display area 2202. A matrix of interconnection traces 2104 are deposited onto the glass substrate. An array of small light sensors 2106, such as small imaging units or small cameras, are implanted into the active display area 2202. The Network Module 903 and system integration object network 102 are connected to further interconnection traces which form the Network Link 106. In one embodiment, the array of small light sensors includes small imaging units or small cameras and the Modular Electronic System performs capturing of multi-dimensional light field information.

In the description herein, numerous specific details are disclosed, such as the description of system components and methods, to provide a thorough understanding of embodiments. One skilled in relevant arts will recognize, however, that the disclosure can be practiced without one or more of the specific details, or with other systems, methods, components, materials, parts, and the like. In other instances, well-known structures, materials, or operations are not shown or described in detail to avoid obscuring aspects of the disclosure.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

1. An object-oriented modular electronic system comprising:
a first plurality of network modules, each addressable as a resource bindable to at least one object and having a respective function module implementing a respective function associated with the at least one object; and
a second plurality of interconnected object network processors, each communicating with a respective one or more of the network modules via a respective one or more serial or parallel interfaces and having a data switch, a local memory and an object indexing engine interconnected and configured to move data associated with the at least one object among the respective one or more network modules, the data switch, the local memory and a neighboring one or ones of the object network processors;
wherein the network modules and the object network processors include electronic circuits and at least one of the network modules or object network processors is individually removable from the modular electronic system for replacement or upgrading, and further network modules or further object network processors can be added to the modular electronic system.

2. The modular electronic system of claim 1 wherein at least one of the network modules includes a network object buffer in which the data associated with the at least one object can be temporarily stored, an object network interface that can communicate with a one of the object network processors via the respective one or more serial or parallel interfaces, and an object channel controller that directs data flow between the function module and the network object buffer and between the network object buffer and the network interface.

3. The modular electronic system of claim 2 wherein the network object buffer in at least one of the network modules includes a network buffer memory, a network buffer processor and a network object wrapper, with the network buffer processor and the network object wrapper coordinating to convert raw data from or to the function module, as temporarily stored in the network buffer memory, to or from the data associated with the at least one object, as communicated via the object network interface to or from the one of the object network processors.

4. The modular electronic system of claim 1 wherein the object network processors are interconnected in a chain, a ring, a tree, a mesh or a hub-and-spoke.

5. The modular electronic system of claim 1 wherein the function modules include a human interface module, a flash memory module, a hard disk module, a wireless or wired communication network module, a DRAM module, a CPU module, a display module and a power supply module.

6. The modular electronic system of claim 1 wherein two or more of the serial or parallel interfaces communicating with a one of the object network processors can be bundled and connected to a one of the network modules to form a communication link with a higher bandwidth as compared to a further communication link having a single one of the serial or parallel interfaces.

7. The modular electronic system of claim 1 wherein two or more of the serial or parallel interfaces communicating with one of the object network processors can be bundled and connected to one of the network modules to form a communication link providing a higher electrical current to or from the one of the network modules as compared to a further communication link having a single one of the serial or parallel interfaces.

8. The modular electronic system of claim 1 wherein the one or more serial or parallel interfaces includes at least one interface conforming to a USB standard.

9. The modular electronic system of claim 1 wherein the one or more serial or parallel interfaces includes at least one interface conforming to a PCIe standard.

10. The modular electronic system of claim 1 wherein the one or more serial or parallel interfaces includes at least one interface conforming to a LightPeak standard.

11. The modular electronic system of claim 1 wherein each of the network modules includes an object network channel communicating between the respective function module and a one of the object network processors to which the network module is connected, via the respective one or more serial or parallel interfaces.

12. The modular electronic system of claim 1 wherein each of two or more network modules includes a DRAM module as the respective function module, and two or more such network modules can be bundled for a higher data throughput as compared to a single such network module.

13. The modular electronic system of claim 1 further comprising a display device into which the second plurality of interconnected object network processors is embedded.

14. The modular electronic system of claim 13 wherein the display device includes an LCD panel.

15. The modular electronic system of claim 14 wherein the LCD panel includes interconnection traces deposited thereupon or therein for connection to one or more of the network modules.

16. The modular electronic system of claim 15 wherein at least one panel implant component that includes at least a portion of a network module or an object network processor is connected to the interconnection traces.

17. The modular electronic system of claim 16 wherein the panel implant component is integrated into the LCD panel using three-dimensional die packaging technology.

18. The modular electronic system of claim 16 wherein the panel implant component is integrated into the LCD panel using thin-film deposit technology.

19. The modular electronic system of claim 1 further comprising a display device communicating with a display module, the display module being the respective function module of one of the network modules.

20. The modular electronic system of claim 19 further comprising one or more sensors embedded in the display device and communicating with one or more of the network modules.

21. The modular electronic system of claim 20 wherein the one or more sensors includes one or more light sensors.

22. The modular electronic system of claim 20 wherein the one or more sensors includes one or more video cameras.

23. The modular electronic system of claim 20 wherein the one or more sensors includes one or more audio sensors.

24. The modular electronic system of claim 23 wherein the one or more audio sensors includes one or more microphones.

25. The modular electronic system of claim 19 further comprising one or more image sensors communicating with a one of the network modules, the respective function module of which is configured to perform two-dimensional tracking of a visual subject using input from the one or more image sensors.

26. The modular electronic system of claim 19 further comprising one or more image sensors communicating with a one of the network modules, the respective function module of which is configured to perform recognition or perception of a visual subject using input from the one or more image sensors.

27. The modular electronic system of claim 19 further comprising two or more image sensors communicating with a one or more of the network modules, the respective function module or modules of which is or are configured to perform three-dimensional tracking of one or more visual subjects using input from the two or more image sensors.

28. The modular electronic system of claim 27 wherein the three-dimensional tracking of one or more visual subjects is used to control images on the display device.

29. The modular electronic system of claim 28 wherein the three-dimensional tracking of the one or more visual subjects includes tracking a hand or a body gesture.

30. The modular electronic system of claim 29 wherein the tracking of the hand or the body gesture is applied as a replacement of a touchscreen control for touchless control of a system having the display device.

31. The modular electronic system of claim 30 wherein the system having the display device is a television, a tablet, a smart phone, a notebook computer, a GPS navigation system, or an ATM.

32. The modular electronic system of claim 28 wherein the display device displays three-dimensional images using 3-D glasses or glasses-free technology and the three-dimensional tracking is used to control at least a portion of the displayed three-dimensional images.

33. The modular electronic system of claim 27 further comprising an array of audio speakers communicating with one or more of the network modules and wherein the three-dimensional tracking of one or more visual subjects is used to control directional projection of sound from the array of audio speakers.

34. The modular electronic system of claim 19 further comprising one or more actuators embedded in the display device and communicating with one or more of the network modules.

35. The modular electronic system of claim 34 wherein the one or more actuators includes one or more light emitters.

36. The modular electronic system of claim 35 wherein the one or more light emitters includes one or more infrared light emitters.

37. The modular electronic system of claim 34 wherein the one or more actuators includes one or more audio speakers.

38. The modular electronic system of claim 1 wherein the data switch in each of the object network processors includes a data switching network controller.

39. The modular electronic system of claim 38 wherein the data switching network controller includes an object network controller that controls a routing of the data associated with the at least one object.

40. The modular electronic system of claim 1 wherein each of the object network processors further includes a memory controller connected to the local memory, the object indexing engine and the data switch.

41. The modular electronic system of claim 40 wherein the memory controller includes an object memory processor that cooperates with the object indexing engine to move the data associated with the at least one object into and out of the local memory.

42. The modular electronic system of claim 1 wherein the local memory in each of the object network processors includes a network object memory.

43. The modular electronic system of claim 42 wherein the local memory in each of the object network processors includes one or more memory stacks, each of which includes one or more DRAMs or one or more flash memories.

44. The modular electronic system of claim 1 wherein the at least one of the object network processors is implemented using three-dimensional die packaging technology.

45. The modular electronic system of claim 1 wherein at least one of the network modules is implemented using three-dimensional die packaging technology.

46. The modular electronic system of claim 1 wherein the first plurality of network modules and the second plurality of object network processors are implemented using three-dimensional die packaging technology.

47. The modular electronic system of claim 1 wherein at least one of the network modules or at least one of the object network processors can be configured via a connection to an Internet.

48. The modular electronic system of claim 1 wherein at least one of the network modules includes a respective power supply or a respective connection to an external power supply and can provide power to a remainder of the modular electronic system.

49. The modular electronic system of claim 48 wherein two or more such network modules, each providing such power, can be bundled to provide more power to a remainder of the modular electronic system than is provided by a single one of such network modules.

50. The modular electronic system of claim 1 wherein the network modules and the object network processors cooperate in an object-oriented event-driven operation.

51. The modular electronic system of claim 1 wherein the local memory of each of the object network processors stores a representation of the networkconfiguration of the interconnected object network processors with attached network modules.

52. The modular electronic system of claim 51 wherein the representation of the network configuration is coded in XML language.

53. The modular electronic system of claim 1 wherein at least one network module is connectable to an Internet or an intranet.

54. The modular electronic system of claim 53 wherein at least one of the network modules or at least one of the object network processors is configurable via the Internet or the intranet.

55. The modular electronic system of claim 1 wherein the modular electronic system is connectable such that a plurality of such modular electronic systems can be connected to create a virtual system.

56. The modular electronic system of claim 55 wherein the virtual system includes an hierarchical connection or a nested connection.

57. An object-oriented modular electronic system comprising:
a first plurality of network modules communicating respective object-oriented data via respective serial or parallel interfaces, the object-oriented data being sent, received or operated upon by a respective function module inside each of the network modules; and
a second plurality of object network processors connected in a network topology, each connected to one or more of the network modules via the respective serial or parallel interfaces and having a data switching network controller, a memory controller, a local memory, and an object indexing engine that controls moving the object-oriented data to and from the one or more of the network modules via the data switching network controller, moving the object-oriented data to and from the local memory via the memory controller and moving the object-oriented data to and from a neighboring one or ones of the object network processors via the data switching network controller;
wherein each of the network modules and the object network processors includes one or more integrated circuits and at least one of the network modules or at least one of the object network processors is individually removable from the modular electronic system for replacement or upgrading, and further network modules or further object network processors can be added to the modular electronic system.

58. The modular electronic system of claim 57 further comprising a network buffer memory in each of the network modules, in which the object-oriented data is temporarily stored en route to or from the respective function module.

59. A modular television comprising:
a first plurality of network modules communicating data via respective serial or parallel interfaces, the data being sent, received or operated upon by a respective function module inside each of the network modules, each network module having a respective network buffer memory for buffering the data, the network modules including a human interface module, a flash memory module, a hard disk module, a wireless or wired communication network module, a DRAM module, a CPU module, a display module and a power supply module as the respective function modules; and
a second plurality of object network processors connected in a network topology, each connected to one or more of the network modules via the respective serial or parallel interfaces and having a data switching network controller, a memory controller, a local memory, and an object indexing engine that controls moving the data to and from the one or more of the network modules via the data switching network controller, moving the data to and from the local memory via the memory controller and moving the data to and from a neighboring one or ones of the object network processors via the data switching network controller;
wherein each of the network modules and the object network processors includes one or more integrated circuits and at least one of the network modules or at least one of the object network processors is individually removable from the modular television for replacement or upgrading, and further network modules or further object network processors can be added to the modular television.

60. The modular television of claim 59 wherein the network topology connecting the object network processors is a chain, a ring, a tree, a mesh or a hub-and-spoke.
